(19) United States
(12) Patent Application Publication
(10) Pub. No.: US 2015/0173447 A1
(43) Pub. Date: Jun. 25, 2015

(54) Interior Clips for a Kippah

(71) Applicant: Jonathan Kaweblum, Hollywood, FL (US)

(72) Inventor: Jonathan Kaweblum, Hollywood, FL (US)

(21) Appl. No.: 14/409,611

(22) PCT Filed: Jun. 21, 2013
(86) PCT No.: PCT/US2013/046984

§ 371 Date: Dec. 19, 2014

Related U.S. Application Data
(60) Provisional application No. 61/662,461, filed on Jun. 21, 2012.

(51) Int. Cl. A42B 7/00; B32B 38/00; B32B 37/06; B32B 37/10; A41G 5/00; B32B 37/18

(52) U.S. Cl. CPC A42B 7/00; A41G 5/0026; B32B 37/18; B32B 37/06; B32B 37/10; B32B 38/0004; B32B 2437/04

(57) ABSTRACT

A clip assembly having a wig/toupe clip for attachment to the underside of a kippah where the clip assembly has a top fabric layer and a bottom fabric layer for supporting and securely holding the wig/toupe clip therebetween and where the bottom fabric is attached to the kippah with a heat sensitive adhesive and the top fabric is attached to the top of the bottom fabric with a heat sensitive adhesive and the wig/toupe clip grasps hair of the user to securely hold the kippah to the wearer's head.

### CROSS-REFERENCE TO RELATED APPLICATIONS

This application claims priority from PCT application PCT/US2013/046984, filed Jun. 21, 2013 and U.S. Provisional Application No. 61/662,461 filed on Jun. 21, 2012 entitled Clips for a Kippah, the disclosure of which is incorporated herein, by reference, in its entirety.

### BRIEF SUMMARY OF THE INVENTION

The present invention is an improved clip mounting assembly for attaching wig/toupe clips to the inside or interior of a kippah. As used herein toupe could also be spelled toupe. Generally a kippah is a small circular head covering worn for religious purposes, however it can be of any shape. Further as used herein the improved clip arrangement can be used for any covering or item used with a hair clip or wig/toupe clip. As used herein, clip or clips shall refer to wig/toupe clips, or other clips of a similar nature. The clips are on a mounting and this mounting assembly can have an adhesive to allow the clips to be attached to the underside of the kippah by applying heat to the clip assembly on a desired kippah.

### BRIEF DESCRIPTION OF THE DRAWINGS

FIG. 1 is a view of the underside of a kippah showing the interior clip assemblies of the present invention attached to the kippah.

FIG. 2 is an exploded view of the interior clip assembly of the present invention.

FIG. 3 is a plan view of the interior clip assembly of the present invention.

FIG. 4 is an exploded cross sectional view of the interior clip assembly taken along lines A-A from FIG. 3 where the wig clip is shown in the closed position.

FIG. 5 is a cross sectional view of the interior clip assembly taken along lines B-B from FIG. 3.

FIG. 6 is a schematic diagram showing application or installation of the interior clip assemblies using a heating and pressure apparatus.

FIG. 7 is a schematic diagram showing application or installation of an interior clip assembly with a handheld heating and pressure apparatus.

FIG. 8 is an enlarged exploded cross sectional view of the present invention taken from line 8-8 in FIG. 1 where the clip assembly is shown in the closed position on a substrate such as a kippah.

FIG. 9 is an enlarged cross sectional view of the present invention taken from line 8-8 in FIG. 1 where the clip assembly is shown in the closed position on a substrate such as a kippah.

FIG. 10 is an enlarged cross section of a decorative bow or other hair attachment using the clip assembly of the present invention to hold the bow for attachment to a wearer's hair.

FIG. 10A is an enlarged cross sectional view of a clip assembly having an adhesive with a removable liner.

FIG. 11 is a bottom view of the bow in FIG. 10 showing the clip assembly of the present invention attached to the decorative article.

### DETAILED DESCRIPTION OF THE PREFERRED EMBODIMENT

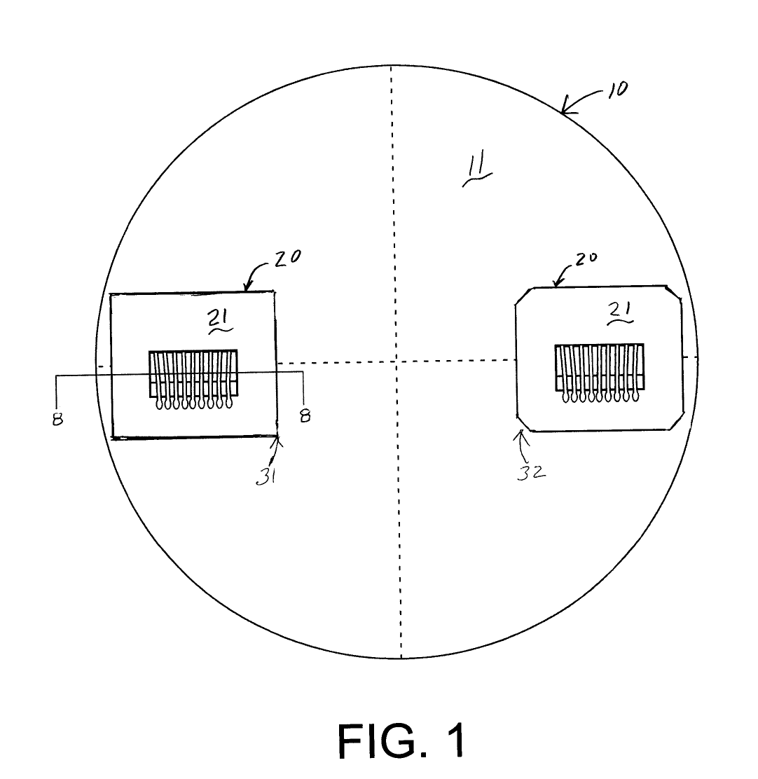

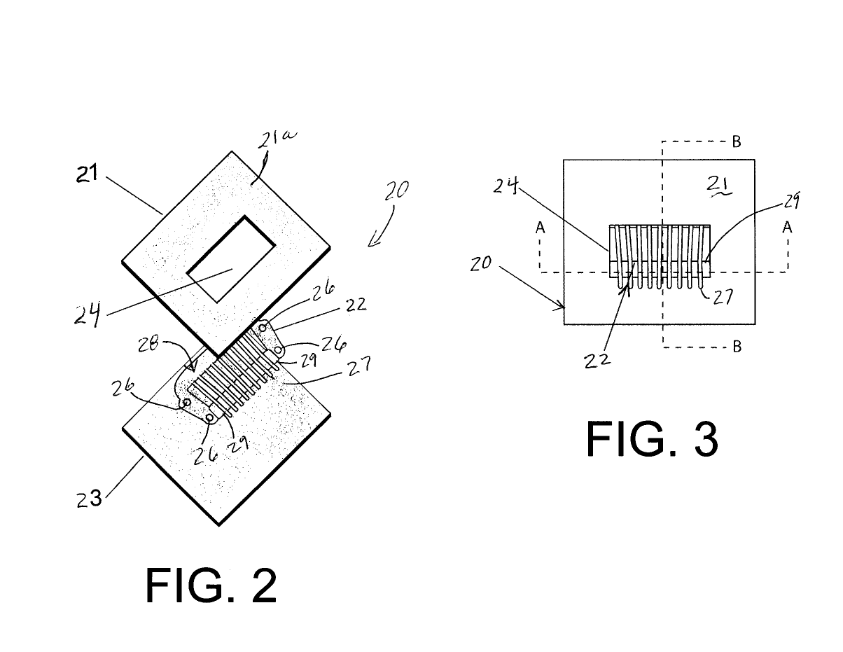

Referring to FIG. 1, is view of a kippah 10 or other head covering showing the underside 11 of kippah 10. Interior clip assemblies 20 are attached to the underside 11. However, a single clip assembly 20 or any number of clip assemblies could be attached to underside 11 of kippah 10. Each interior clip assembly 20 as seen in FIG. 2 is composed of three main parts an upper layer patch fabric 21, a wig/toupe clip 22 and a lower layer patch fabric 23. Upper layer patch 21 includes an opening 24 constructed and arranged to correspond to wig clip 22. Both the upper layer 21 and lower layer 23 are made of fabric or other material that preferably has an adhesive activated by heat and pressure.

The clip 22 is sewn with threads 25a and 25b to the top 23a of the bottom layer 23 using the already existent holes 26 on the sides of the clip 22 indicated by threads 25a. The top layer 21, which is nominally larger than the bottom layer 23 in length and width is then sewn to the bottom layer 23 indicated by threads 25b, encasing the clip 22 between the upper layer patch 21 and the lower layer patch 23. The upper layer patch 21 has a rectangular window 24 cut out from its center. When clip assembly 20 is assembled preferably the teeth 27 of the clip 22 will protrude from window 24 to allow hair of a wearer to be gripped by teeth 27. The main body 28 of clip 24 thus includes the holes 26, the teeth 27 and a cross bar 29. Hair of the user is gripped between teeth 27 and cross bar 29, when the clip 22 is opened to grip the hair of a user and then closed such that teeth 27 grip hair against bar 29. With the gripped hair, when clip assembly 20 is attached to a kippah 10, the kippah 10 is securely held on the head of a wearer by the wearer's hair. The holes 26 are used to receive threads 25a to sew clip 22 securely to the bottom layer 23. The holes 26 and threads 25a are concealed between upper layer 21 and lower layer 23, when clip assembly 20 is assembled.

The standard wig/toupe clip 22 is readily available on the market. It is essentially composed of extruding vertical members or teeth 27 that snap and unsnap above a perpendicular horizontal member or bar 29 covered in rubber. The snapping perpendicular members 27 are intended to firmly trap hair strands, the hair of the wearer of the kippah 10, between the teeth 27 and bar 29. The rubber coating of the horizontal member 29 is designed to create friction further aiding the ability of clip 22 to firmly grasp hair strands. The body of the wig/toupe clip 22 has holes 26 in each corner designed to sew the clip 22 to other substrates.

Upper layer 21 relative to clip 22 has an upper distal side 21a and an upper proximal side 21b, proximal to clip 22. Lower layer 23 relative to clip 22 has a lower proximal side 23a proximal to clip 22 and a lower distal side 23b. Upper layer 21 and lower layer 23 have an adhesive material within or on fabrics 21 and 23, that is heat and pressure sensitive as known in the art such that when heat and pressure is applied the material adheres to materials it is in contact with.

As can be seen in FIGS. 2, 3, 4 and 5, the fabric patch 21 is at least slightly larger in area than patch 23 and clip 22 as well. Likewise, patch 23 is at least slightly larger in area than clip 22.

In a preferred embodiment, upper layer 21 and lower layer 23 are twill fabrics, though they can be made of any durable fabric material. A preferred fabric is polyurethane laminate (PUL). Most PUL fabric is made by laminating lightweight polyester interlock knit fabric to a 1 mil thick film of polyurethane. There are two processes used for lamination: solvent lamination which fuses the fabric and polyurethane film into a single monolithic fabric and hot melt which uses heat and pressure activated glue/adhesive to adhere the fabrics together. The materials need a combination of high heat, typically greater than 300 to 350 degrees Fahrenheit and high pressure to make them adhere.

The upper layer fabric 21 has a rectangular opening cut out 24 on the surface of layer 21. The upper layer fabric 21 has an adhesive heat seal activated backing on side 21b proximal clip 22. The lower layer fabric 23 has adhesive backing on side 23b. Lower layer fabric 23 is smaller in both length and width than the upper layer fabric 21.

The entire clip assembly 20 is attached and adhered to the interior side of kippah 10. The clip 22 is attached to lower layer fabric 23, side 23a. This is done preferably by first using a threaded attachment where threads 25a are looped through each of the four openings 26 of clip 22. These openings 26 as seen in FIG. 2 are located at the outer edges of clip 22. The thread 25a does not have to be tight, but tight enough such that clip 22 is initially held in place against fabric layer 23 side 23a. Then, upper fabric layer 21 is stitched in place with threads 25b holding fabric layer 21 to fabric layer 23 at the four corners of each of fabric layers 21 and 23. The stitching of threads 25b do not have to be tight, but tight enough to hold fabric layers 21 and 23 together with clip 22 therebetween. Clip 22 is thus sandwiched between each of the two fabric layers 21 and 23, with clip 22 arranged to have teeth 27 protruding from opening 24 as seen in FIG. 3.

The lower layer fabric 23, the wig/toupe clip 22 and the upper layer fabric 21 are assembled one on top of each other in the aforementioned order from bottom to top. The entire clip assembly 20 is sewn together loosely connecting the three parts of the clip assembly 20 together as described above. When combined, the perpendicular teeth members 27 and the horizontal perpendicular rubber coated bar member 29 of the wig/toupe clip 22 are to be exposed through the cut out 24 in the upper layer fabric 21.

The clip assembly 20 is installed and attached to any substrate such as a kippah 10 using a device that applies heat and pressure to the assembly 20 and to the substrate 10. The heat and pressure process serve two simultaneous functions. The first function is that the entire assembly 20 is firmly attached to the substrate or kippah 10.

The adhesive is laminated into the knit materials of upper fabric layer 21 and lower fabric layer 23 that creates a laminated substance in the fabrics 21 and 23 before the clip assembly 20 is assembled. Once exposed to heat and pressure the adhesive is activated to adhere to whatever it is in contact with. When the assembly 20 is assembled, side 21b adheres to side 23a where they come in contact with one another. Side 21b also adheres to the clip 22 where those two parts come in contact to securely support and hold and maintain the clip 22 in position relative to the clip assembly 20 within which clip 22 is encased. Further it can be seen that the size of fabric layer 21 is slightly greater than the size of fabric layer 23 creating a border portion 21c on both sides of layer 23 perpendicular to bar 29 and a border portion 21d on both sides of layer 23 parallel to bar 29. Border portions 21c and 21d are contiguous forming an overhang lip 21c and 21d around and overlapping layer 23 that comes in contact with kippah 10. Borders 21c and 21d that overlap layer 21 provides additional adhesion to holding and adhering fabric layer 21 and support clip 22 and assembly 20 in place on kippah 10. The entire side 23b of layer 23 and the outer border 21c and 21d of layer 21 adhere directly to kippah 10.

The second function is that due to the heat seal activated backings on side 21b of layer 21, the wig/toupe clip 22 is firmly secured between the top layer fabric 21 and the bottom layer fabric 23. The body 28 of the wig/toupe clip 22 is now firmly supported and held in place between the upper layer fabric 21 and the lower layer fabric 23. Because the upper layer fabric 21 is longer and wider than the lower layer fabric 23, the border area 21c and 21d of fabric 21 of the upper layer fabric 21 is also directly secured to the substrate or kippah 10.

Once the assembly 20 is secured to the substrate 10, the rectangular opening 24 allows the vertical members 27 and the perpendicular horizontal rubber coated member 29 of the wig/toupe clip 22 to function as intended in firmly securing to hair strands. The resulting clip assembly 20 attached to substrate 10 now has the ability to firmly secure kippah 10 to hair strands of the wearer.

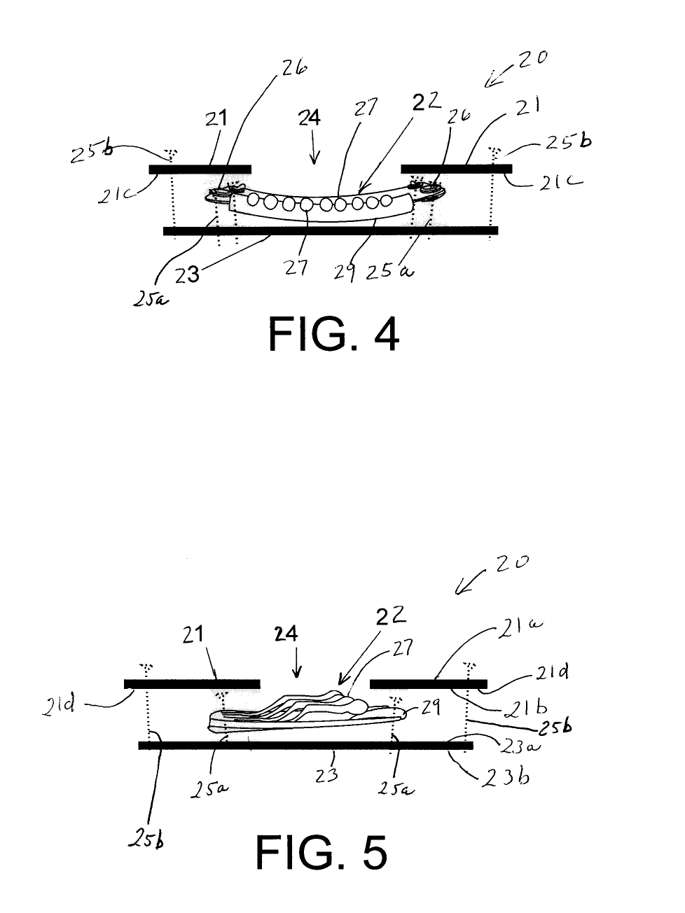

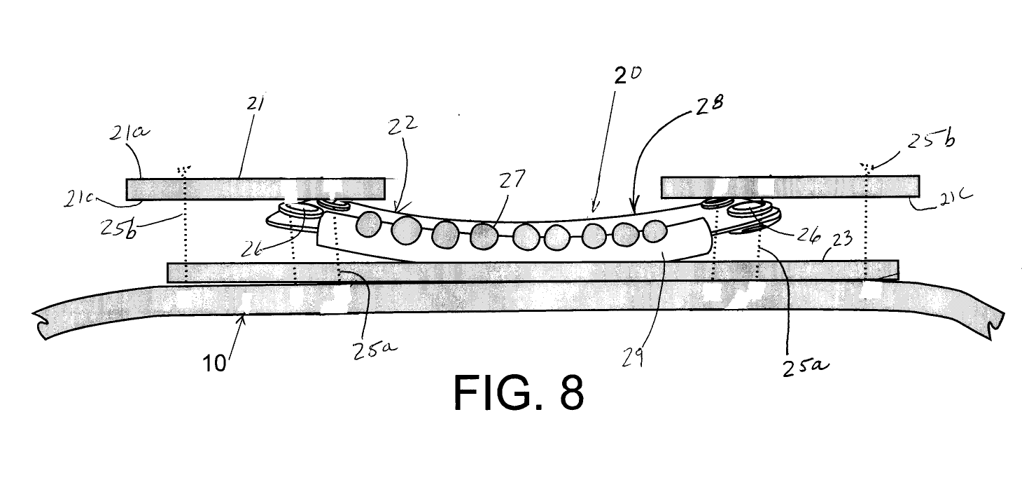

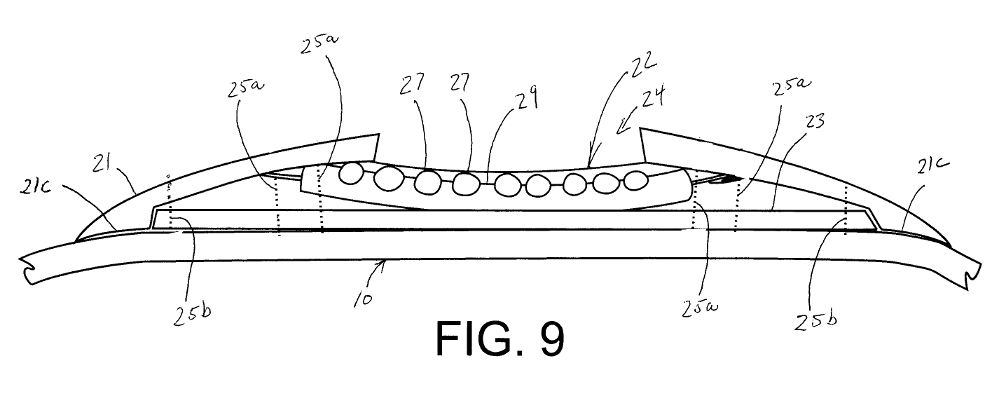

When clip 22 is in the closed position, as shown in FIGS. 4, 8 and 9, the teeth 27 on the clip 22 will grasp strands of hair between themselves and the rubber perpendicular member 29. The benefits of the assembly 20 include that it will increase the overall strength of the clip 22 and will ensure that the clip 22 stays permanently secured to the substrate 10.

As seen in FIG. 1, top fabric layer 21 is shown with square corners 31 and in an alternate embodiment with angled corners 32. Changing the corner 31 from a 90 degree corner as shown at 31 to two 45 degree corners 32 as shown at 32 improves the clip assembly 20 ability to distribute the force need for better adhesion to substrate 10.

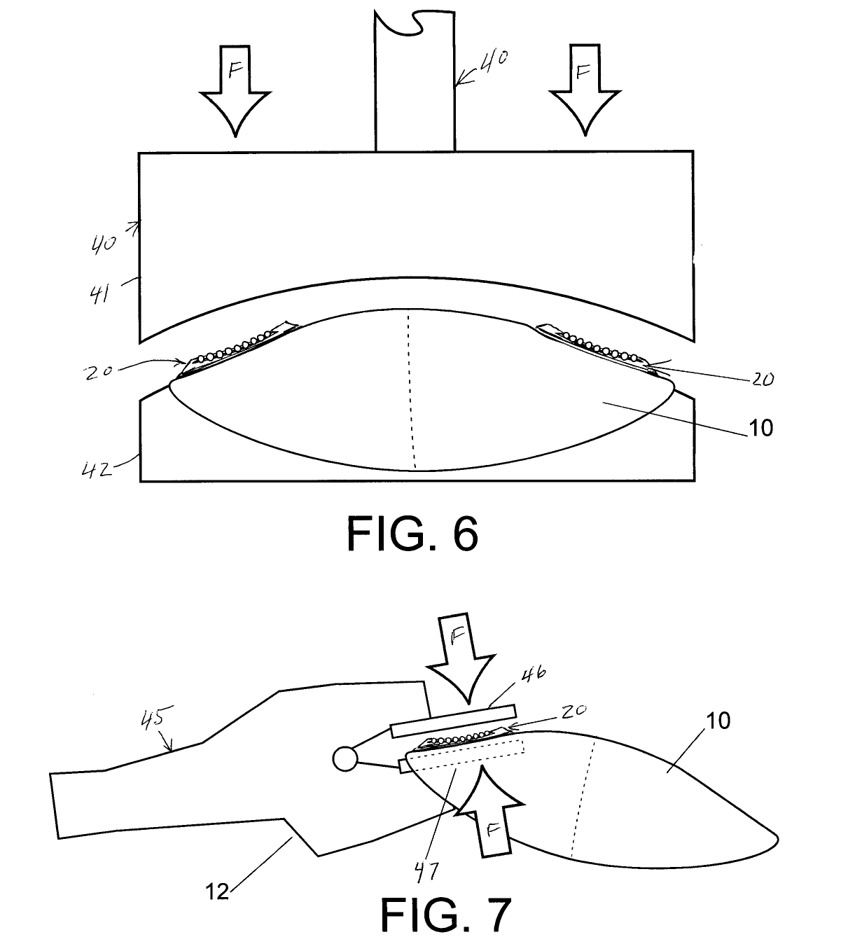

Referring to FIGS. 6 and 7, two types of heat and pressure presses are shown. A stationary device 40 has an upper pressure heat plate 41 and a lower pressure heat plate 42. The substrate or kippah 10 is positioned on lower plate 42 in an inverted or open position exposing the location to place one or more clip assemblies 20. When each clip assembly 20 is positioned, a force F, shown by arrows with an F therein showing the direction of pressure to be applied, is exerted at the same time heat is applied to the substrate 10 within each plate 41 and 42 for a sufficient time to adhere the clip assembly 20 to the substrate 10 and the portions of the assembly 20 one to another. Likewise handheld device 45 has a first pressure heat plate 46 and a second pressure heat plate 47. The kippah 10 is in an inverted position with the assembly 20 placed in position so that a force F is exerted at the same time heat is applied to the substrate 10 within each plate 46 and 47 for a sufficient time to adhere the clip assembly 20 to the substrate 10 and the portions of the assembly 20 one to another.

The present invention further allows the manufacture of the clip assemblies 20 as described herein where the clip assembly 20 is held in place by the threads 25a and 25b. In this stage the three parts of the clip assembly 20 namely the top fabric 21, the clip 22 and the bottom fabric 23 are held together by threads 25a and 25b but the adhesive has not yet been activated.

The clip assemblies 20 are thus ready to be applied to a substrate or kippah 10. The clip assemblies 20 can be sold to wholesalers and retailers of kippahs 10, such that when a customer of the retailer chooses a kippah 10 from the retailer's inventory, the clip assemblies 20 can then be immediately installed and adhered to the inside of the kippah 10 at the point of sale. This allows a retailer to have inventory of kippahs 10 that can be sold with or without interior clip assemblies 20, since the clip assemblies 20 do not have to be installed in the kippah 10 until a kippah 10 is selected by a customer for purchase.

It is further envisioned herein that the adhesives described herein as activated upon heat and pressure can also be other adhesives which adhere upon contact with or without heat and/or pressure activation. Specifically such an adhesive would preferably be applied to the surface 21b and 23b. In this manner fabric 21 would hold clip 22 firmly in place against surface 23a and border 21c and 21d would attach directly to the substrate 10, and surface 23b would adhere directly to substrate 10.

The present clip assemblies 20 can also be used for and on many articles having a substrate 10 for attachment to the hair of a user, such as wigs, toupes, hats, hair pieces, hair extensions, bows or other hair embellishments, and other such devices having a substrate 10 to receive the clip assembly for attachment to the hair of a wearer.

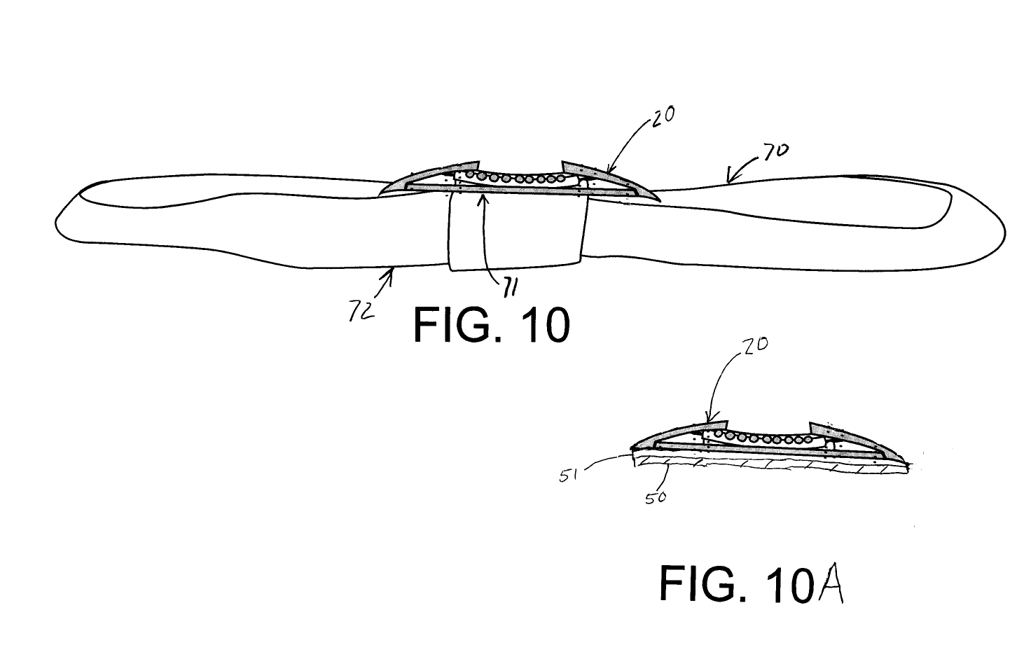

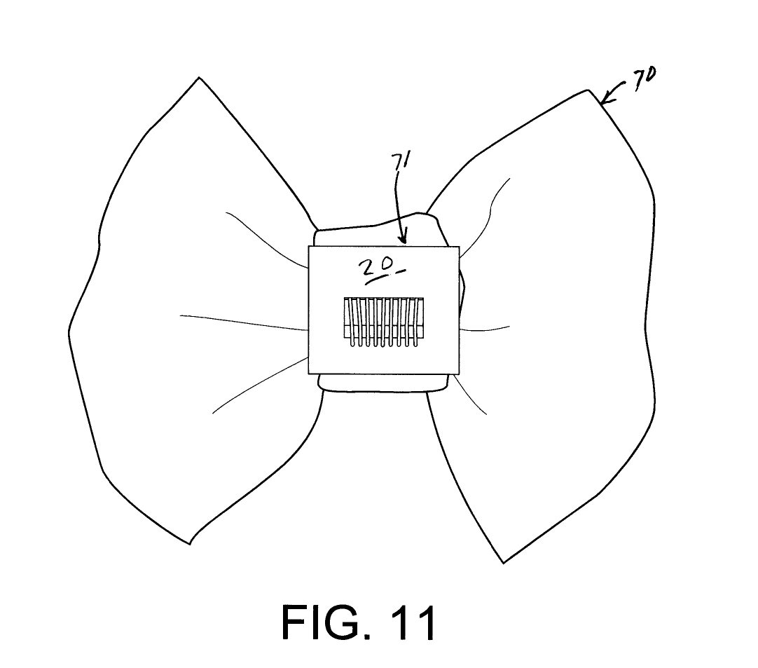

Specifically an article such as a hair embellishment such as a bow 70 as shown in FIG. 10 having on one side or first side an attachment area 71 which could be a substrate for receiving clip assembly 20 and on its second other side 72 a decorative hair embellishment such as a bow 70 for wearing the bow 70 attached to the hair of a wearer. In this example, the clip assembly 20 can be sold directly to purchasers of articles such as bow 70. The clip assembly 20 would be completed such that the three components, the layer 21 is securely attached to clip 22 and layer 23. As shown in FIG. 10A, side 23b of layer 23 and border areas 23c and 23d would have an adhesive 51 with a removable liner 50 such that a wearer of the decorative article could attach the article 70 to the clip assembly 20 by removing the liner 50 to expose the adhesive 51 on side 23b and attach the clip assembly 20 directly to the attachment area 71 of the decorative article 70. Where as described above, in the event the decorative article has a substrate 71, the clip assembly 20 is attached directly to substrate 71 and the decorative item 70 is attached to the other side of substrate 71.

It is to be understood that the preceding is merely a detailed description of the invention, and that alterations to the disclosed invention can be made in accordance with the disclosure without departing from the spirit and scope of the invention. The preceding description is not meant to limit the scope of the invention. The scope of the invention is to be determined by the appended claims and their equivalents.

1-10. (canceled)

11. A clip assembly for attachment to a substrate comprising:
a clip;
a first fabric layer having a first side for receiving said clip thereon, said first fabric layer having an area larger than an area of said clip, said first fabric layer having a second side configured for being affixed to the substrate;
a second fabric layer overlaying said clip and said first fabric layer, said second fabric layer having an opening formed therein, said opening exposing portions of said clip.

12. The clip assembly as set forth in claim 11,
wherein the substrate is a kippah.

13. The clip assembly as set forth in claim 11,
wherein said first fabric and said second fabric have adhesive that is activated upon application of heat and pressure.

14. The clip assembly as set forth in claim 13,
wherein said clip is a wig or toupee clip.

15. The clip assembly as set forth in claim 11,
wherein said portions are portions which affix to hair of a user.

16. The clip assembly as set forth in claim 11,
wherein said second fabric layer has an area that is larger than said area of said first fabric layer

17. The clip assembly as set forth in claim 11,
wherein the substrate is a decorative item.

18. The clip assembly as set forth in claim 11,
wherein said first fabric and said second fabric have adhesive that is activated upon application of pressure.

19. The clip assembly as set forth in claim 11,
wherein said first fabric and said second fabric have adhesive that is activated on the peripheral edges of said second fabric to attach said peripheral edges of said second fabric against the substrate upon application of heat and pressure.

20. The clip assembly as set forth in claim 11,
wherein said clip is held to said first fabric with thread, and said second fabric is held to said first fabric with thread, and
said first fabric and said second fabric have adhesive that is activated upon application of pressure, and heat.

21. A method of providing a clip assembly comprising:
attaching a clip to a first patch of fabric;
attaching a second patch of fabric to the first patch of fabric and the clip with the clip disposed between the first patch of fabric and the second patch of fabric.
selecting a kippah from a group of kippahs,
applying the clip assembly to the kippah using heat and pressure.

22. The method according to claim 21, further comprising: selecting a kippah from a group of kippahs, applying the clip assembly to the kippah using heat and pressure.

23. The method according to claim 21, further comprising providing an opening in the second patch of fabric for exposing at least a portion of the clip.

24. The method according to claim 21 wherein said clip is attached to said first patch of fabric with thread, and said second fabric is attached to said first fabric with thread.
